(19) United States
(12) Patent Application Publication
(10) Pub. No.: US 2009/0216347 A1
(43) Pub. Date: Aug. 27, 2009

(54) Neuro-Fuzzy Systems

(76) Inventors: Mahdi Mahfouf, Sheffield (GB); Derek Arthur Linkens, Sheffield (GB); George Panoutsos, South Yorkshire (GB); Minyou Chen, Sheffield (GB)

Correspondence Address: MCDONALD HOPKINS LLC, 600 Superior Avenue, East, Suite 2100, CLEVELAND, OH, 44114-2653, US

(21) Appl. No.: 11/887,668

(22) PCT Filed: Mar. 30, 2006
(86) PCT No.: PCT/GB2006/001178

§ 371 Date: Apr. 16, 2009

(30) Foreign Application Priority Data
Mar. 30, 2005 (GB) 0506384.7

(51) Int. Cl. G05B 13/04; G06N 7/02; G06N 5/04

(52) U.S. Cl. 700/31; 706/52; 700/50; 700/145; 702/179; 706/48

(57) ABSTRACT

A systematic method of generating a neuro-fuzzy structure a system comprises: recording data relating sample system outputs to sample system inputs, granulating the data to identify rules relating the inputs to the outputs, measuring information loss during the granulation process to enable identification of an optimum number of rules, and constructing the network so that it has a plurality of processing elements corresponding to the rules.

The present invention relates to neuro-fuzzy networks or fuzzy inference systems, and in particular to the use of such systems in the control of other systems, apparatus or processes.

Fuzzy rule-based systems have been widely used in a variety of engineering areas such as data mining, pattern recognition, and process control. This is mainly due to the expressiveness of fuzzy logic that permits the representation of certain kinds of uncertainty often present in real systems. Also, the if-then rules of fuzzy models are easy to manipulate, easy to understand and to a certain extent are domain-independent. Fuzzy modelling is a very active research field in fuzzy logic Systems. Compared to mathematical modelling and neural network modelling, fuzzy modelling possesses some distinctive advantages, such as the facility for the explicit knowledge representation in the form of if-then rules, the mechanism of reasoning in human-understandable terms, the capacity of taking linguistic information from experts and combining it with numerical data, and the ability to approximate complex non-linear functions with simpler models. Also rapid developments of hybrid approaches, based on fuzzy logic, neural networks and genetic algorithms, enhance the fuzzy modelling technology significantly.

Most fuzzy modelling efforts concentrate on improving modelling performance while maintaining system transparency. Depending on the particular application one can drive the model towards performance (the neuro-fuzzy evolutionary approach) or towards transparency (such as the Mamdani approach).

The present invention provides, according to a first aspect, a systematic method of generating neuro-fuzzy network models for non-linear high

Preferred embodiments of the present invention will now be described by way of example only with reference to the accompanying drawings in which:

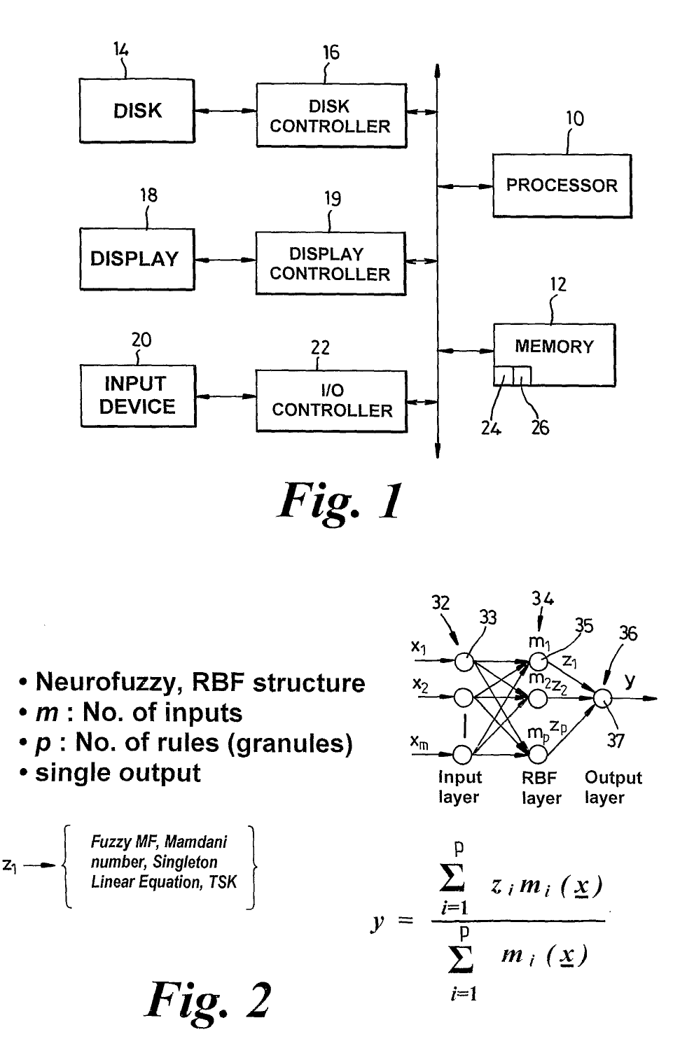

FIG. 1 is a schematic diagram of a computer system arranged to develop a neuro-fuzzy structure according to an embodiment of the invention;

FIG. 2 is a diagram showing a neuro-fuzzy structure according to an embodiment of the invention;

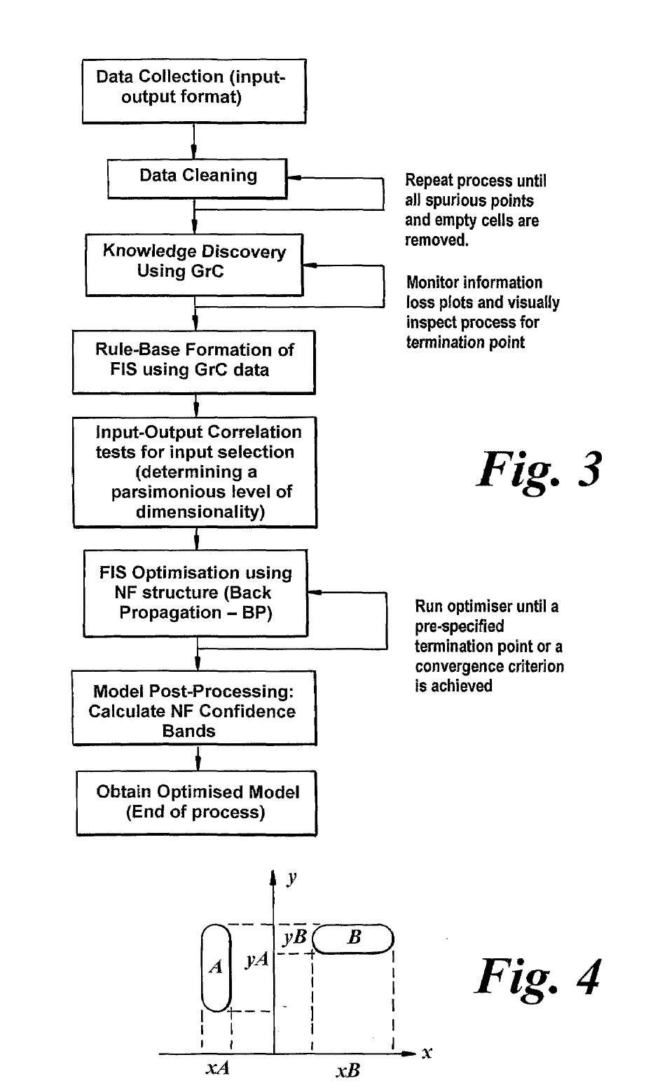

FIG. 3 is a flow diagram showing a method of developing a neuro-fuzzy structure according to an embodiment of the invention;

FIG. 4 is a diagram showing granules formed from data used in the method of FIG. 3;

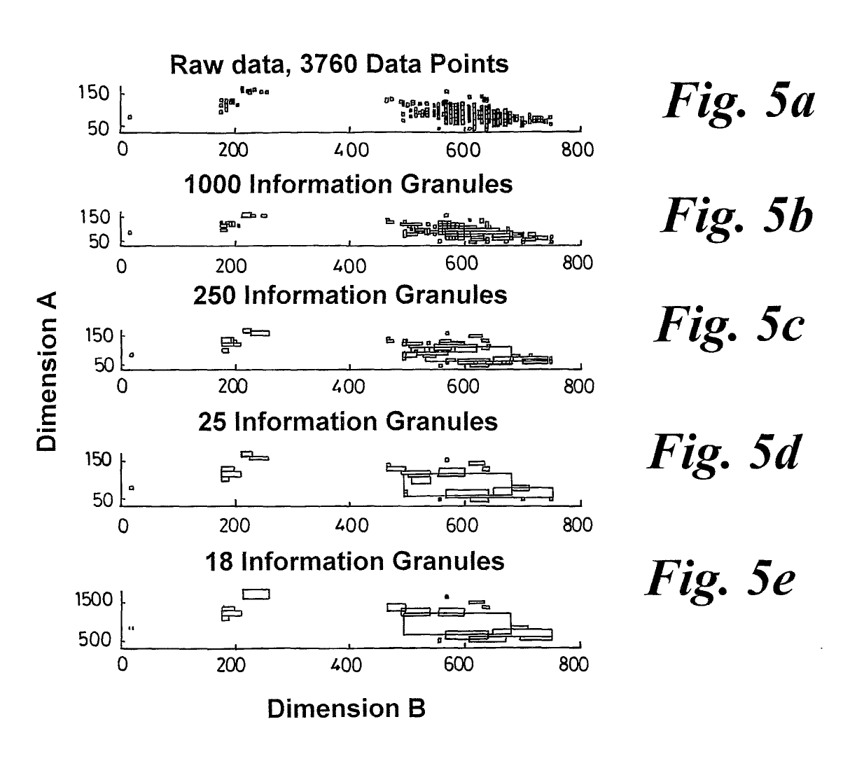

FIG. 5a shows data collected as a first part of the method of FIG. 3;

FIGS. 5b, 5c, 5d and 5e illustrate granulation of the data of FIG. 5a;

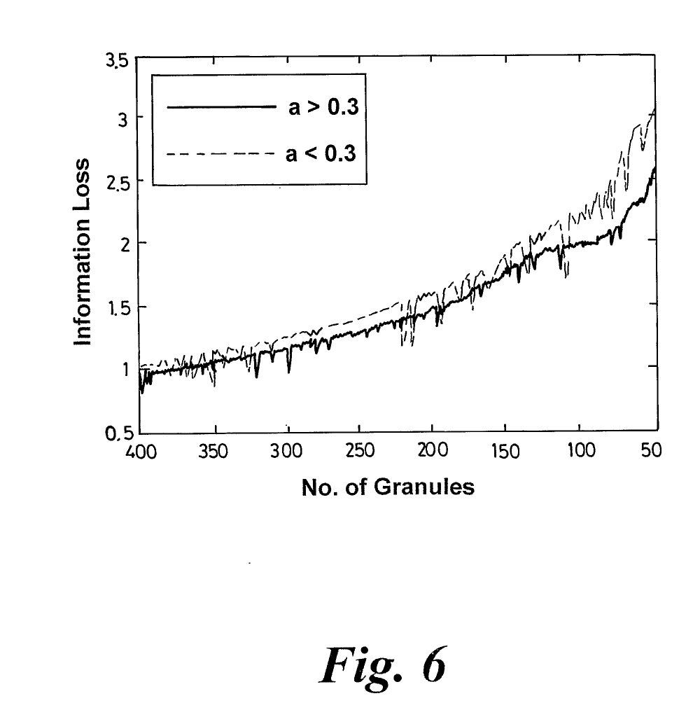

FIG. 6 is a graph showing information loss during the granulation of FIGS. 5b to 5e

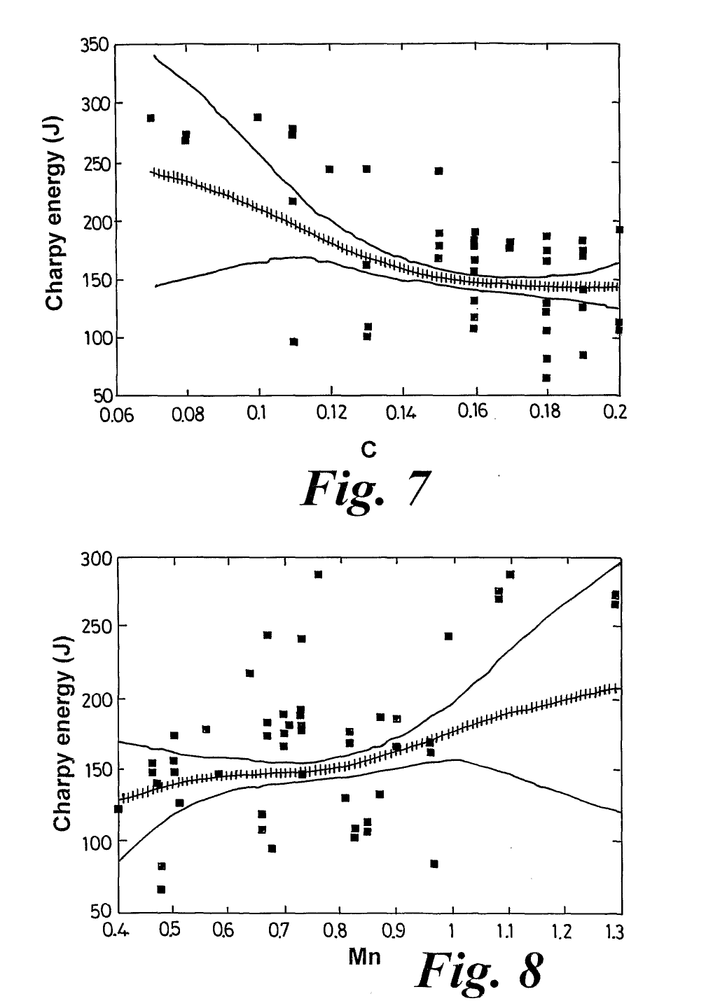

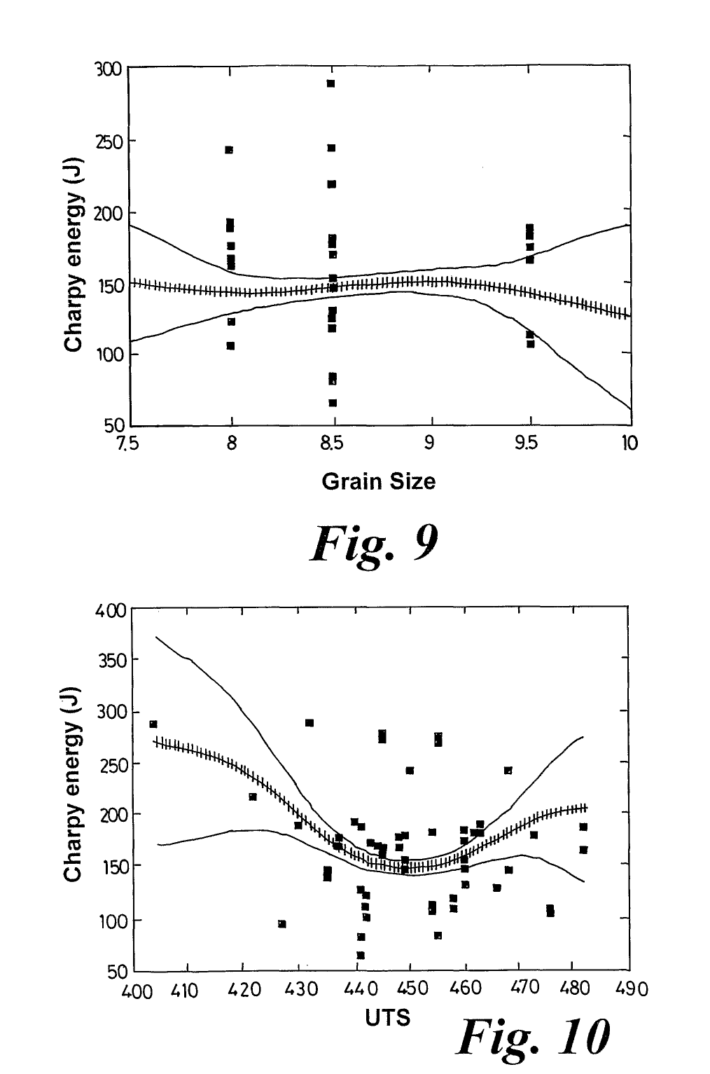

FIGS. 7, 8, 9 and 10 show error bands in the model formed in the method of FIG. 3;

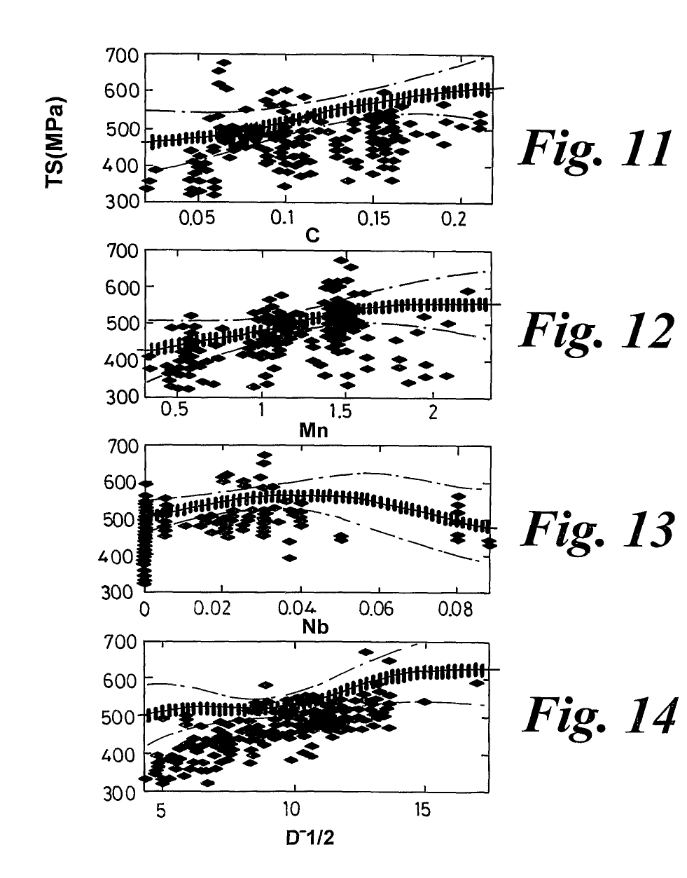

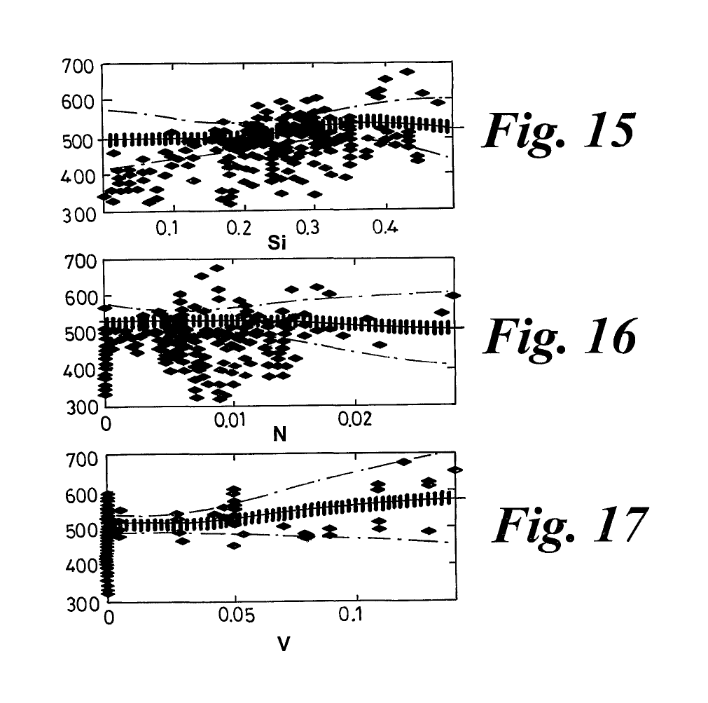

FIGS. 11, 12, 13, 14, 15, 16 and 17 show further error bands for the model formed in the method of FIG. 3;

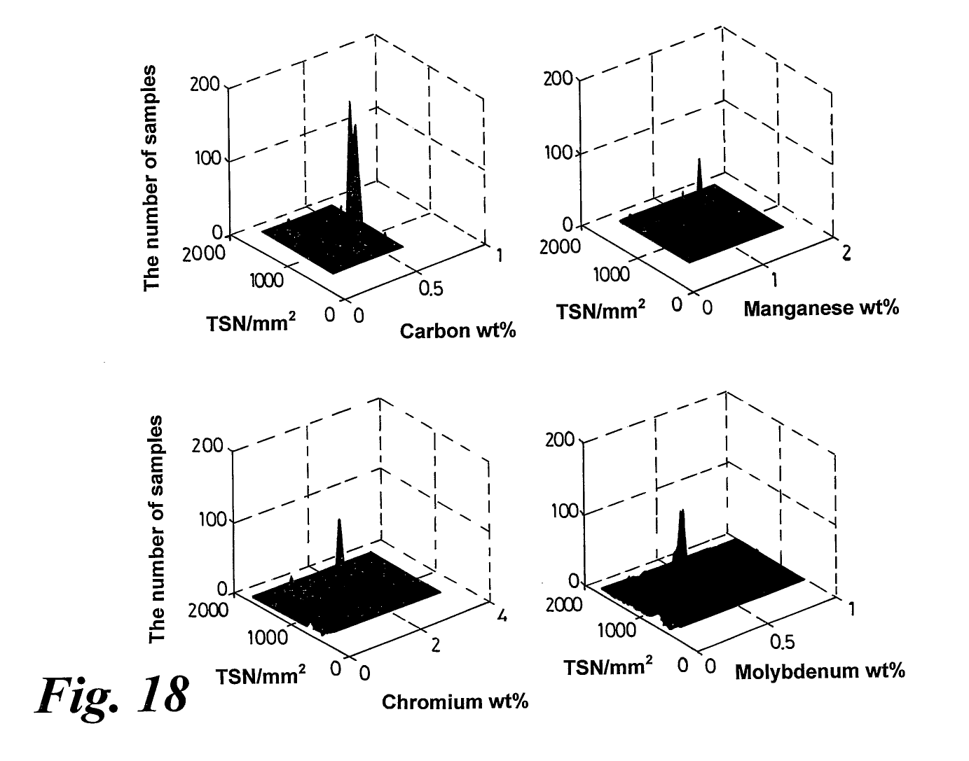

FIGS. 18a, 18b, 18c and 18show the distribution of sample data points in a method according to a second embodiment of the invention;

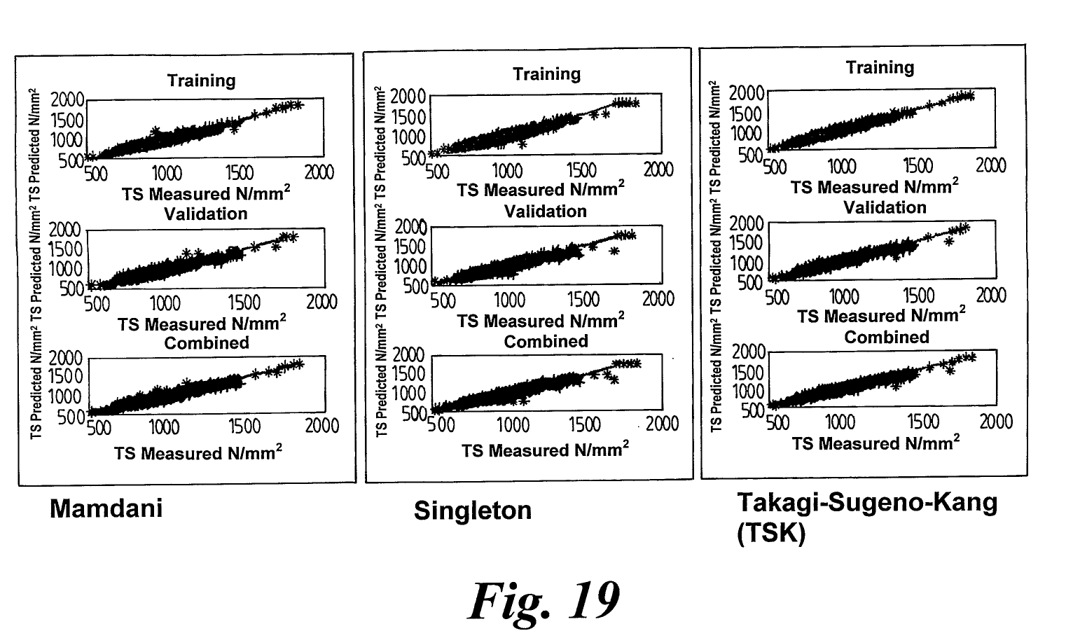

FIG. 19 shows the relationship between measured results and predicted results from different models of the second embodiment and modifications thereto;

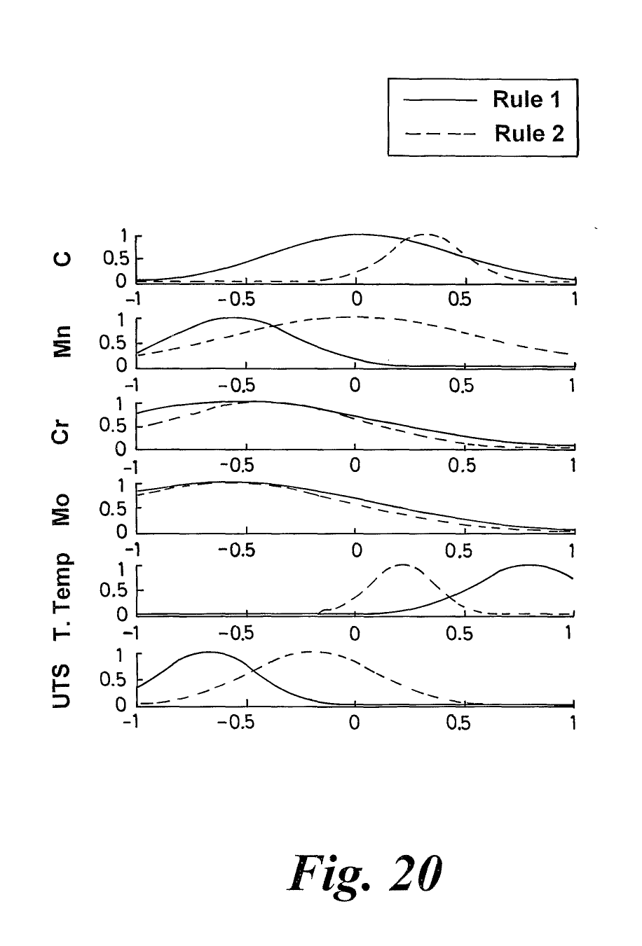

FIG. 20 shows examples of rules forming part of the model of the second embodiment;

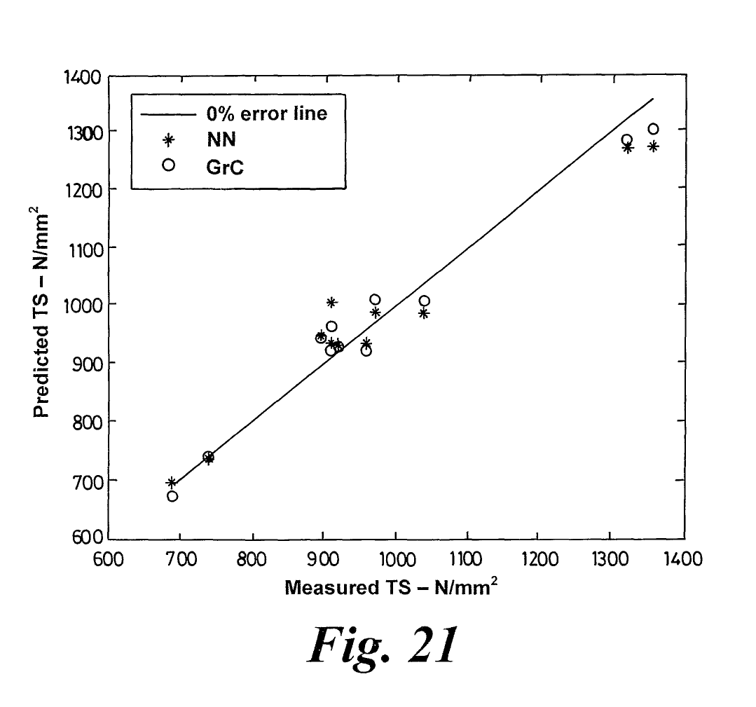

FIG. 21 is a graph comparing results of a granular computing method according to the invention and a neural network method;

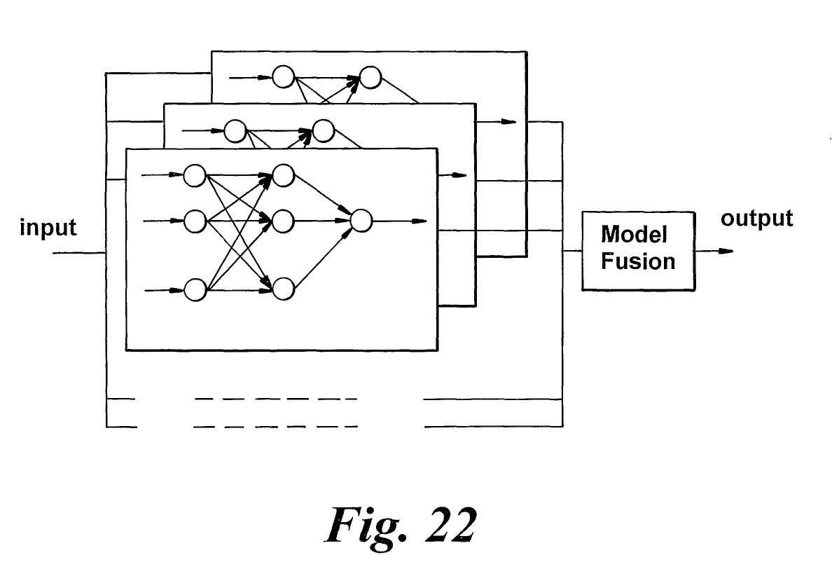

FIG. 22 is a schematic representation of a model of a further embodiment of the invention;

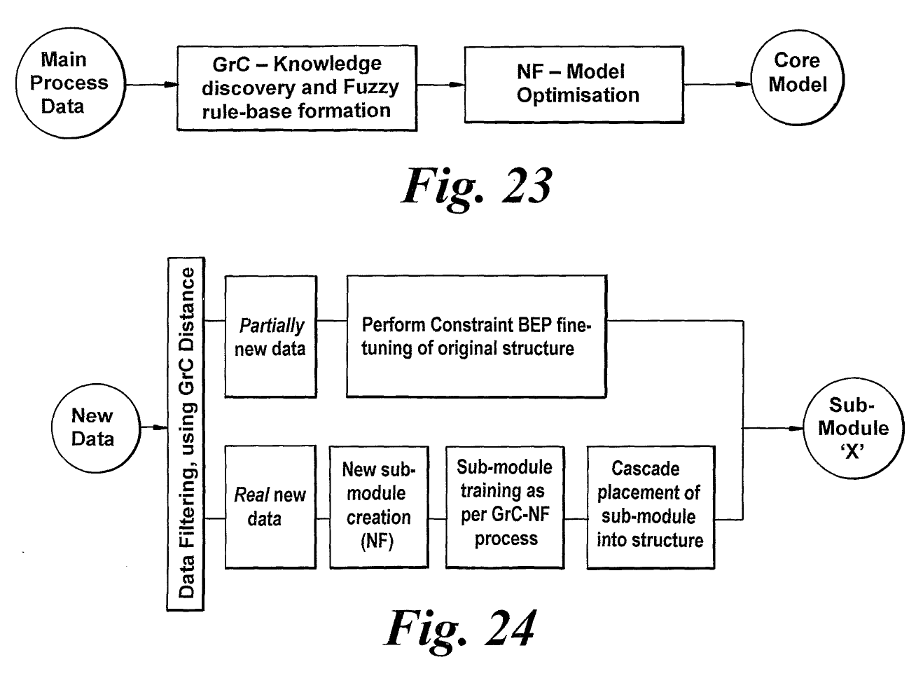

FIG. 23 is a flow diagram illustrating in simplified form the model generation process of FIG. 3;

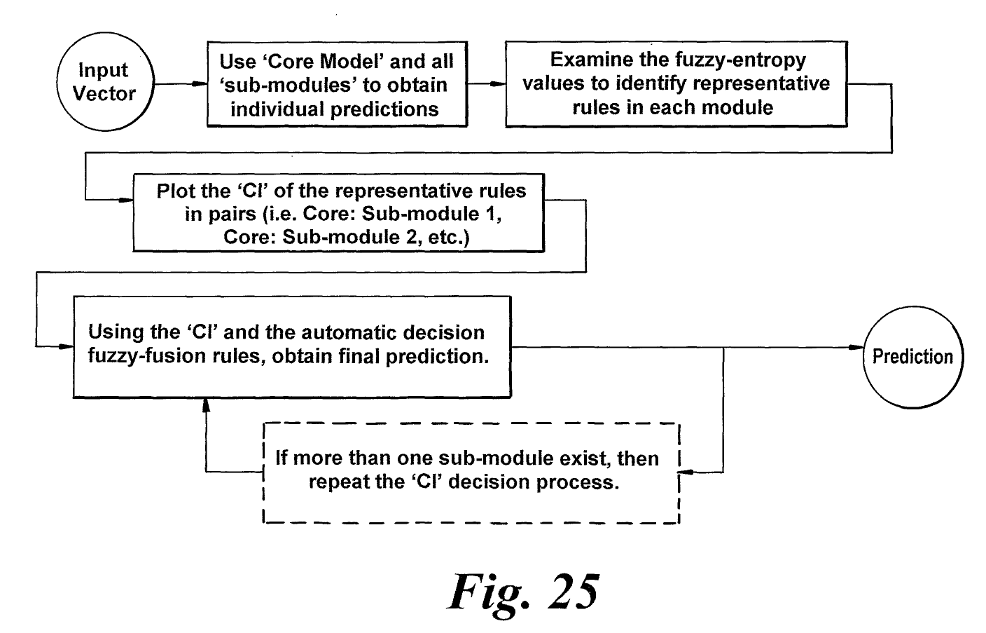

FIG. 24 is a flow diagram of a model updating process including the model fusion process of FIG. 25;

FIG. 25 is a flow diagram showing use of the model of FIG. 25 to predict an output from new inputs;

FIG. 26 shows the entropy of a number of rules used to select representative rules during the process of FIG. 25;

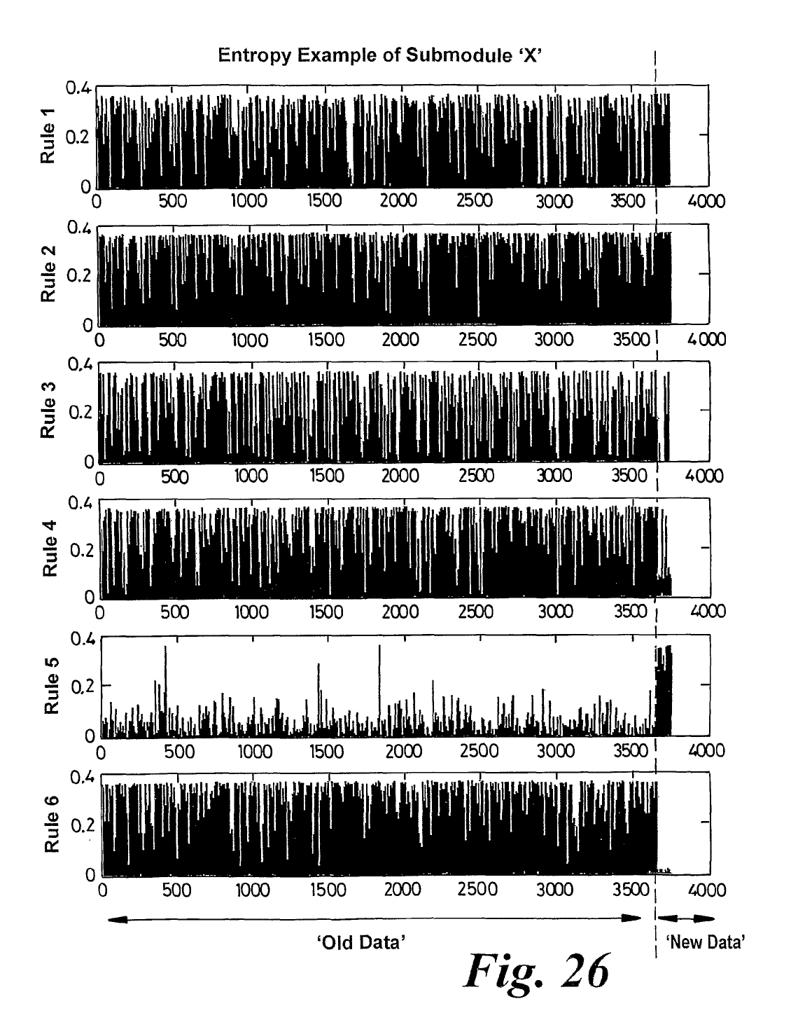

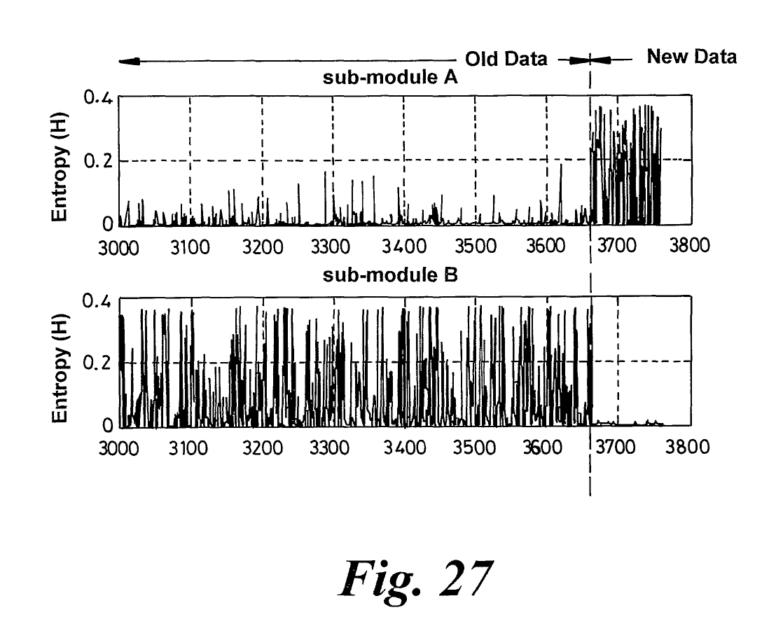

FIG. 27 is a graph showing entropy data obtained in part of the process of FIG. 26c;

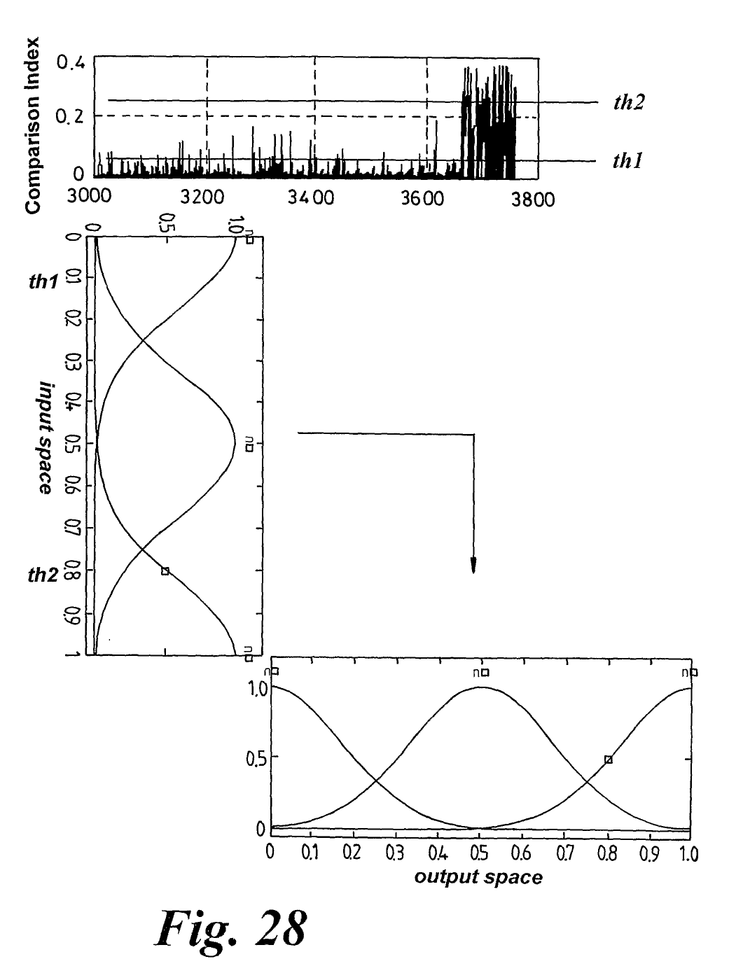

FIG. 28 illustrates a process for the selection of sub-modules forming part of the process of FIG. 26c;

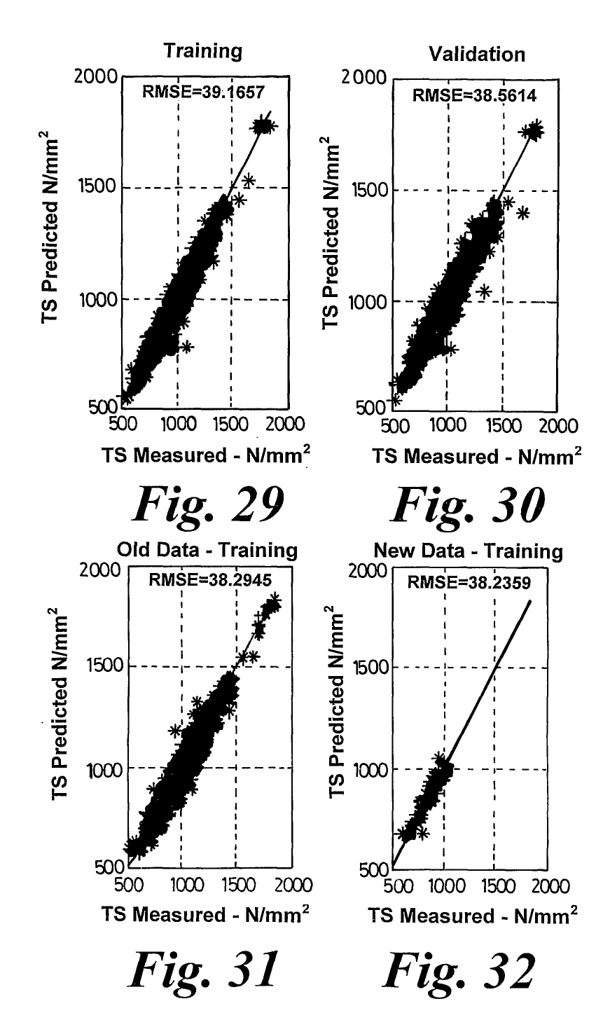

FIGS. 29 to 34 graphically represent data obtained in an example of the process of FIG. 26;

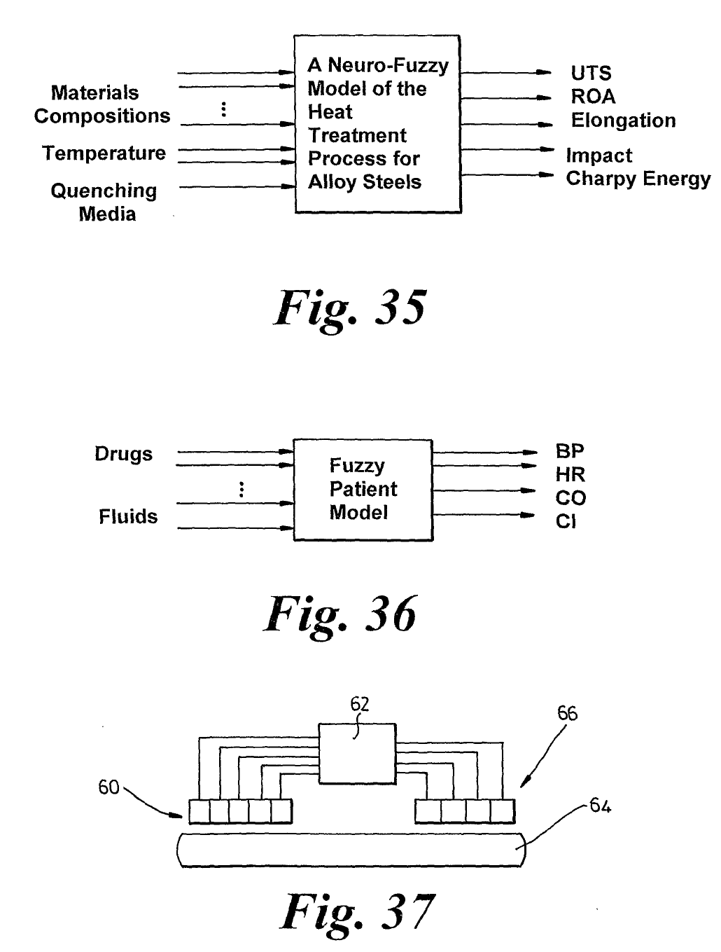

FIG. 35 is a generalized diagram of the model produced by the method of FIG. 3;

FIG. 36 is a generalized diagram of a model produced according to a further embodiment of the invention; and

FIG. 37 is a schematic diagram of a system according to a further embodiment of the invention for controlling the flow of drugs and fluids to a patient.

Referring to FIG. 1, a system for developing a neuro-fuzzy inference system takes the form of a computer having a processor 10, and memory 12, a disk 14 and disk controller 16 arranged to store data, a display 18 in the form of a video display unit, controlled by a display controller 19, and input devices 20, that allow data to be input to the computer, and controlled by an I/O controller 22. It will be appreciated that this system is only described generally, and that a computer system suitable for any particular application can be selected.

Referring to FIG. 2, a radial basis function (RBF) neuro-fuzzy (NF) inference system, also referred to as a fuzzy inference system (FIS), 30 is arranged to model a process having a number of inputs and a number of outputs. The system has, as a general form, an input layer 32 made up of a number of neurons 33 arranged to receive data inputs xₘ corresponding to the system inputs, a middle layer or radial basis function (RBF) layer 34 made up of a number of neurons or rules 35 that receive data from the various input layer neurons and produce output signals according to rules that they represent, and an output layer 36 made up of a number of neurons 37 arranged to receive the signals from the middle layer neurons 35 and produce outputs corresponding to the system outputs. In this case there is only one output. In developing the FIS, data is collected giving output values for a large number of combinations of input values. This data is analysed to identify the rules relating the outputs to the inputs, which will then form the RBF layer. They therefore each correspond to a neuron or rule in the network connected to some of the inputs and some of the outputs.

The form of the signals zₚ from the RBF layer to the output layer can take many forms depending on the type of fuzzy system that is being used. For a Mamdani type system, they will be in the form of fuzzy MFs (Membership Functions), for a singleton system, they will be crisp numbers, and for a TSK type system, they will be linear equations (static or dynamic). The final output y of the system will be of the form given in FIG. 2.

The FIS is developed as a series of processing elements making up a program stored in the memory 12 of the computer. The various steps that will be described in the process of developing the FIS are also carried out on the computer.

Referring to FIG. 3, the first step in the development of a neuro-fuzzy inference system according to an embodiment of the invention is a data collection step. In this general case the process that is to be modelled has a number of inputs and a number of outputs. In a specific example where the method is being used to predict alloy properties, the inputs are the amounts of each component of the alloy, the temperatures of heat treatment, and the quenching media, and the outputs are the properties of the alloy, such as ultimate tensile strength (UTS), reduction of area (ROA), elongation, impact and Charpy energy. Each of the inputs and outputs can be considered as a separate variable, and each piece of data is made up of values for each of the inputs and resulting values for each of the outputs, and can therefore be considered as a point in multi-dimensional space, with each of the dimensions corresponding to one of the variables. The data collection step therefore involves selecting values for the inputs, measuring the resultant values of the outputs, and combining the input and output values to define a point in the multi-dimensional space. This is repeated for different input values to build up a collection of data points. In the example of modelling alloy properties, this is done by producing alloys having a variety of contents, tempering temperatures and quenching media, and measuring the properties mentioned above. This data is collected and stored in the memory of the computer.

The next step in the process is data cleaning, which is carried out by the computer using appropriate software in a normal manner that is not important for this invention.

The next step is knowledge discovery using granular computing (GrC), carried out by a granular computing software component 24. This is a process of granulation in which the raw data points are combined into granules which form the basis for the fuzzy rules of the fuzzy inference system. This process will be described in more detail below.

After the granulation of the data points is completed, the next step in the process is the formation of the rules for the fuzzy inference system from the granules, which will also be described in more detail below. These rules form the neurons or rules in a neuro-fuzzy network, in this case a radial basis function (RBF) neuro-fuzzy (NF) structure or network.

The next step is input selection in which the number of inputs used on the model is reduced. This is done by checking how much each input affects the output and by removing inputs that affect the output the least, and also checking for correlation between inputs. If two inputs are closely correlated in terms of their effect on the outputs, then one of them can be removed from the model. This will be described in more detail below.

Once the initial rule base has been formed and the number of inputs reduced, the FIS is then optimized using the neuro-fuzzy structure. This is done using known methods that will not be described in detail. Optimisation continues until a predetermined termination point or convergence criterion is achieved.

There then follows a model post-processing step in which confidence bands are calculated for the model. The way in which these bands are calculated will be described in more detail below, and they are used to judge whether the model is sufficiently accurate in different operating regions.

These steps result in a fully optimized model that can then be used.

The granulation process is a two-step iterative process that involves the following data characteristics:

the geometrical multidimensional distance between granule;

the circumference of granules (which is a multidimensional quantity);

the cardinality of granules (which is the number of sub-granules per granule); and

the granule density (which is derived from the size and cardinality).

The iterative process of data granulation includes two main steps: identifying the two most compatible granules or data points, and merging them to form a new granule. Firstly the entire database is scanned in order to find the two ‘most compatible’ granules. Compatibility is measured based on a compatibility function calculated for every pair of data points using equation (1):

Comp=MaxDist−Dist e^{-α((C}^{_{REL}}^{)(L}^{_{REL}}⁾⁾ (1)

Where:

MaxDist is the maximum possible multidimensional distance between two granules, given by the equation:

$$Max Dist = {\sum }_{k = 1}^{no . of dimensions} ( max Lim - min Lim )$$

For the normalised fuzzy space it should be noted that:

maxLim=1 and minLim−−1|

and:

Dist is the multidimensional distance between the two granules, given by:

$$Dist = {\sum }_{k = 1}^{no . of dimensions} ( Average Distance Between Granules )$$

and:

α is a weighting factor, to weight the compatibility requirement towards the geometrical distance or the exponential factor. Depending on application, is generally between 0.6 and 0.01

C_{REL} is the Relative Granule Cardinality, given by the equation:

$${C}_{REL} = \frac{\begin{matrix}Cardinality of Merged Granules \text{:} \\ {\sum }_{k = 1}^{no . of sub \text{-} granules in A} ( 1 ) + {\sum }_{k = 1}^{no . of sub \text{-} granules in B} ( 1 )\end{matrix}}{Max Possible Cardinality \text{:} No . of all data points}$$

L_{REL} is the Relative Granule Length, given by:

$${L}_{REL} = \frac{\begin{matrix}Length of Merged Granule \text{:} \\ {\sum }_{k = 1}^{no . of dimensions} ( Granule Length )\end{matrix}}{Max Possible Length \text{:} {\sum }_{k = 1}^{no . of dimensions} ( max Length )}$$

For the normalised fuzzy space it should be noted that a granule can cover the whole space [−1,1], therefore:

maxLength=(maxL−minL)=2

By defining the compatibility equation as described above, cardinality and length are proportional to compatibility (in an exponentially weighted manner) which tends to produce high cardinality and large granules. This is suitable for Fuzzy rule-base extraction applications. An alternative approach would be to replace C_{REL}L_{REL} in equation (1) with C_{REL}/L_{REL} so that the length is inversely proportional to compatibility i.e. to require small dense granules. This would be suitable for data compression applications.

When the two most compatible granules have been found, they are merged into a new granule consisting of the two old ones using equation (2).

New Granule=Merge(Granule a, Granule B) (2)

The Merging function Merge(A,B) operates as follows:

$$Merge = \{ \begin{matrix}New Cardinality = Cardinality A + Cardinality B \\ New Coordinates = [ \begin{matrix}min ( lim 1 A , lim 1 B ) , \\ max ( lim 2 A , lim 2 B )\end{matrix} ] \\ Recalculate total multidimensional Length \\ Store new Granule ' C ' \\ Delete Granules ' A ' , ' B '\end{matrix}$$

i.e. the cardinality C of the new granule is calculated as the sum of the cardinalities of the two merged granules. The coordinates of the new granule are then calculated from the coordinates of the old granules by taking, for each dimension, the highest maximum from the two granules and the lowest minimum from the two granules and using those as the limits of the merged granule. The total multidimensional length is then calculated from the new coordinates, and the new granule stored, and the two merged granules deleted.

This merging step is then repeated until the desired information condensation is achieved. This can be a predefined set-point or an online set-point monitored by some function. When the granules have been merged to the optimum degree, the granules are then used to form a rule base for the fuzzy interference system. In order to describe how this is done, a multi-input single-output (MISO) system will be considered.

Referring to FIG. 4 as an example it is possible to extract the following rule-base:

x :Input space

y :Output space

Rule A :If Input is ‘xA’ then output is ‘yA’

Rule B :If Input is ‘xB’ then output is ‘yB’

In the case of a Fuzzy rule-base extraction the granule orientation is very important as it cam set the input-output sensitivity, Rule B is more sensitive in the output space (and less in the input) than rule A. Therefore by driving the algorithm towards one orientation or the other it is possible to alter the input-output sensitivity of the rule-base so that it suits a specific problem. The orientation control can be performed by adding ‘weights’ in each dimension during each granule's length calculation.

Other considerations that influence the algorithmic process are ‘granule overlap’ and ‘granule orientation’. When two granules overlap each other their compatibility is the maximum possible, so that they are merged immediately.

FIGS. 5a to 5e show how the merging of granules reduces their number and increases their size. FIG. 5a shows an example of 3760 initial data points. These are obviously shown in two-dimensional space and therefore only two variables A and B are shown, although in practice the data is in multi-dimensional space as described above. FIGS. 5b, 5c, 5d and 5e show the results of merging the granules to produce 1000, 250, 25 and 18 granules respectively.

In order to determine the optimum degree of granularity, and hence the optimum number of rules that will be formed, the amount of information lost by each merging of two granules is monitored. In the merging of two granules, the new (merged) granule consists of the two old ones (sub-granules) and therefore it contains the information of both granule A and B. The fuzzy rules described by the two original granules are:

Rule A :If Input is ‘xA’ then output is ‘yA’

Rule B :If Input is ‘xB’ then output is ‘yB’

These are replaced in the merging process by the more general rule for the merged granule C:

Rule C :If Input is ‘xC’ then output is ‘yC’

Where xC=[min(xA; xB); max(xA; xB)] and yC=[min(yA; yB); max(yA; yB)]

as described by the merging function. Hence, some information resolution is lost and the new fuzzy rule is more general and less accurate than both rules A and B together. However fewer rules produce a simpler system, an d there is therefore a balance between accuracy and simplicity. It is possible to ‘quantify’ the information that is lost by defining it as the average multidimensional distance between the sub-granules before the merging, as used above in equation (1).

By plotting the total loss of information against the number of granules as the number of granules decreases, it is possible to determine the progress of the granulation process. FIG. 6 shows an example of such a plot. Smooth and constant slope of the plot means that the merged granules are close together. Frequent ‘spikes’ and changing slope angle reveal that the process is close to termination. The information loss data can be monitored by a user, for example if it is displayed as a plot on the display screen 18 of the computer. A process expert can then determine the number of final granules required for modelling (termination by definition) and input this to the granular computing module 24 using the input devices 20. Alternatively the granular computing module 24 carrying out the granulation process can be arranged to monitor the information loss data and, when it meets certain conditions, such as a predetermined slope or rate of loss of information, stop the granulation process (termination by information loss monitoring).

Once the number of granules from which to forms the fuzzy inference system rules has been selected, the rules are formed as described above. These rules combine to form an initial structure for the fuzzy rule-base that will be used as a model of the process that is being investigated. However, this initial model then needs to be optimized by selecting the most important parameters for each rule, and simplifying the rule to include only those parameters.

The process for selecting the most significant input variables for the model is as follows. Once the initial model has been constructed, all of the inputs are set to 1 except for one variable that is to be tested. The tested variable is then varied over a number of values, and the outputs recorded for the range of input values. This is repeated for each of the input variables. The variation in outputs produced by varying the input is then calculated for each input, and an importance factor defined for each input variable that is related to the amount of variation in the outputs that resulted from varying the input variable. The importance factor is then ranked for all of the input variables, and all of the input variables with an importance factor below a selected threshold are removed from the model. Then closely related input variables are identified by calculating the correlation between selected pairs of input variables. For pairs of variables that are closely correlated to each other, the importance factors are compared, and the variable with the lowest importance factor removed. This results in an optimized model with a smaller number of variables.

The fuzzy model-based input selection method can be summarised as following steps, each of which is carried out by an input selection software module running on the computer:

1) Generate an initial fuzzy model with p rules using self-organising network or fuzzy granulation.

2) All antecedent clauses (the ‘IF’ part of the fuzzy rules) are assigned the value 1 except for one dominant testing input variable, then calculate the model output

zᵢ=(zᵢ₁, xᵢ₂, . . . , zᵢₙ)

corresponding to each input variable.

$${z}_{ik} = \frac{{\sum }_{j = 1}^{p} {μ}_{ij} ( {x}_{ik} ) {y}_{j}^{*}}{{\sum }_{j = 1}^{p} {μ}_{ij} ( {x}_{ik} )}$$

$${μ}_{ij} ( {x}_{ik} ) = exp \{ - [ {( \frac{{x}_{ik} - {x}_{ij}^{*}}{{σ}_{ij}} )}^{2} ] \}$$

$$i = 1 , 2 , … , m ; k = 1 ,$$

3) Calculate the variation of the output vectors zᵢ by:

Rzᵢ=max(zᵢ)−min(zᵢ).

4) Define the importance factor of the ith input by:

F i=Rzᵢ/Rm: where Rm=max {Rzᵢ}.

5) Rank the importance of all input variables according to their corresponding Fᵢ values.

6) Remove all the input variables with respect to Fᵢ<λ, where λ=(0,1) is the pre-defined threshold.

7) Recognising the closely related input variables; Calculate the correlation functions between the selected input variables by

$$ρ ( {x}_{i} {x}_{j} ) = \frac{\frac{1}{N} {\sum }_{k = 1}^{N} ( {x}_{i} - {\overline{x}}_{i} ) ( {x}_{j} - {\overline{x}}_{j} )}{\sqrt{{φ}_{{x}_{i}} {φ}_{{x}_{j}}}}$$

where: ρ(xᵢ xⱼ)∈[0,1], x̅ᵢ̅, x̅ⱼ̅, φₓ_{_{i,φx}}_{ⱼ}

are the means and variances of vector xᵢ and xⱼ respectively, i, j=1, 2, . . . , r; r is the number of selected input variables.

8) if |ρ(xᵢ xⱼ)|>τ, then xᵢ is closely related with xⱼ, thus, remove the one which has a smaller value of importance factor from the list of selected significant input variables, where τ is the threshold.

The reliability of the model is then determined by defining confidence bands. For a simple single input, single output system, the model could be represented as a line on a two-axis graph. For multi-input and multi-output systems, a rule can be considered as a line in multidimensional space. The confidence bands are therefore defined around the line, and their width increases as the accuracy of, or confidence in, the rule decreases.

The confidence bands are related to the local density of the data space as well as the NF network itself. The algorithmic procedure for calculating the confidence bands is as follows. This is carried out by a confidence band module 26 on the computer.

1. Firstly the summation of the membership degree to each granule (NF-RBF Neuron) is computed for all training data,

$${N}_{gi} = {\sum }_{k = 1}^{n} gik ( {x}_{k} ) ;$$

$$gik ( {x}_{k} ) = \frac{{\prod }_{j = 1}^{m} {u}_{ij} ( {x}_{kj} )}{{\sum }_{i = 1}^{p} {\prod }_{j = 1}^{m} {u}_{ij} ( {x}_{kj} )}$$

Where the following symbols have the following meanings:

k: Number of training data points.

j: Number of fuzzy rules—[Radial Basis Function (RBF) Neurons],

i: Number of model inputs.

x: Input vector.

u: Input fuzzy weights.

gᵤ: Fuzzy RBF Neuron output

2. Then the standard deviation Si associated to the ith granule is calculated.

$${S}_{i} = \sqrt{\frac{{\sum }_{k = 1}^{n} {gikE}_{k}^{2}}{{N}_{si} - 1}}$$

where:

E. Output Error (predicted—actual)

3. The confidence band Ci associated to the ith unit is then calculated based on a T-distribution.

$${C}_{i} = {t}_{a} {S}_{i} \sqrt{1 + \frac{1}{{N}_{si}}}$$

4. The confidence band C for the model output associated to the current input x is then calculated using a weighted average algorithm:

$$C = {\sum }_{i = 1}^{p} \frac{{C}_{i} {N}_{si}}{{\sum }_{i = 1}^{p} {N}_{si}}$$

5. A correction factor is then calculated as the ratio of the minimum distance between current input and every granule, to the maximum distance between the granules, using the relationship.

$$Cf = \frac{{D}_{min}}{{D}_{max}} ;$$

$${D}_{min} = {{min}^{p}}_{i = 1} \{ ‖ x - {v}_{i} ‖ \} ;$$

$${D}_{max} = {{max}^{p}}_{i = 1 \\ i \neq j} \{ ‖ {v}_{i} - {v}_{j} ‖ \}$$

6. The confidence band is then modified using the previously calculated correction factor

CB=C*Cf

Examples of error bands in a model for predicting the mechanical properties of alloy steels are shown in FIGS. 7 to 10. Each of these figures shows the 95% confidence error band in two dimensions, around the model predictions, specifically for the output variable Charpy energy against inputs carbon content, manganese content, grain size and UTS respectively. The training data points are also shown in these figures.

Similarly FIGS. 11 to 18 show the 95% confidence bands in two dimensions, in the relationship between tensile strength and composition of C, Mn, Nb, D-½ (the average grain size of the metal structure), Si, N and V.

When the error bands have been determined, they can be used as a measure of the reliability of the model for different values of the input and output variables. This is useful when the model has been set up, and is being used to select inputs for the process that will produce required outputs.

Using the modelling methods described above, it will be appreciated that various processes can be controlled. For example, if an alloy is needed having particular properties, then firstly sample alloys are made and tested, and a model set tip as described above. Clearly data from previously tested alloys, or even the complete model that has been previously produced can be used if they are available. Then the properties of the required alloy are input to the computer using the input device 22. The computer is then arranged to run the software application that includes the model, which will produce as an output details of the components and their quantities and the tempering temperature and quenching media that will produce an alloy with the required properties. The application also determines the size of the error band associated with those inputs for the model and produces an output signal, which is used for example to produce a display on the display screen, indicative of the error band. This enables a user to decide whether he has enough confidence in the model to use the results. If he has, then the result can be used. If not, then either a different model can be used, or further sample data collected and used to improve the model or create a new one that is more accurate in the region that is required. Once the input variables have been established from the model, the required components of the alloy as indicated by the model can be mixed together in the proportions indicated by the model, and the alloy tempered and quenched as specified by the model.

In a modification to this embodiment, rather than displaying an indication of the accuracy of the model in the region in which is it operating, the system may be arranged to check the accuracy of the model by checking the width of the error band in that region. Provided the accuracy meets predetermined criteria, then the required alloy components, temperatures and other inputs are determined and output for the user. However, if the accuracy criteria are not met, then the system issues a warning to the user, for example on the display screen. It may also display the required inputs it has determined from the model, together with the warning as to their inaccuracy, or it may not display the required inputs at all.

The results of using the method described above on sample data of FIG. 5a will now be described. A highly dimensional data set taken from the steel industry is used for modelling purposes. Each set of points represents 15 input variables and 1 output variable. The input variables include both: a) the chemical composition of steel (i.e. % content of C, Mn, Cr, Ni etc.) and b) the heat treatment data (Tempering temperature, Cooling medium etc.). The output variable (the steel property to be modelled—predicted) is the Tensile Strength (TS). The TS data set consists of 3760 data points representing steels of various grades. The large TS data set was used to challenge the ability of GrC to extract and capture information within large and complex databases. A visualisation of the data density in three out of the sixteen possible dimensions is presented in FIG. 18.

The data distribution and density is complex and not homogenous which represents a difficult task for the GrC algorithm to capture knowledge effectively within the sixteen dimensional space.

Modeling the non-optimised FIS can assess the initial performance of the information granulation process. Using the same system structure as described above with reference to FIGS. 2 and 5 a number of FISs are formed using various levels of information granulation data (various number of rules-information granules). In this case the TS data set is used for the modelling process; 75% of the data are used for the training (information granulation) and the rest is used for the validation of the extracted information granulation model.

The following table presents the performance (Root Mean Square Error—RMSE) of the non-optimised FIS-GrC models, for various levels (number of rules) of information granulation.

TABLE 1
Performance of non-optimised FIS-GrC using
various levels of granulation, TS Data

| No. of rules- | | |
|---|---|---|
| Information | RMSE | RMSE |
| granules | Training | Validation |
| 25 | 104 | 120 |
| 50 | 83 | 105 |
| 100 | 58 | 92 |
| 150 | 37 | 82 |

As expected (from the theory) the higher the number of information granules the better the performance of the system. The drawback is that the transparency level and maintainability of the FIS-GrC system is reduced as the number of granules is increased. The imbalance between the training and validation performance, which can be seen in Table 1, was expected because the fuzzy structure is not yet optimised. The performance of the validation (generalisation ability) will be dramatically improved by optimising the fuzzy inference engine.

Training and validation performance is comparable to NN, NF-Mamdani and NF-TSK performance levels. The introduction of ‘noise’ during validation is expected as dome unseen data points are not included in the rules' structure.

A visualisation of two of the optimised Mamdani fuzzy rules is shown in FIG. 20. Each variable is shown individually (only 6 out of 16 are shown and only two rules instead of fifty for simplicity).

As can be seen from FIG. 20, the input variables include chemical compositions as well as heat treatment data coded into fuzzy sets. Heat treatment data include test depth and size of the sample taken, test site were the alloy was produced, hardening and tempering temperature and cooling medium. The transparency of the system can be verified by the linguistic interpretability of the rules, i.e. using FIG. 20, Rule 1: “High T. Temp→low TS” and by observing Rule 2: “Lowering T. Temp→TS is increased”. This modelled behaviour is also confirmed by theory and expert's (metallurgist) knowledge.

By comparing the FIS-GrC modelling technique to current black-box modelling techniques (NN, NF) it is possible to see the similarity in performance level between all methodologies for the given paradigm.

For instance, a NN approach has also been investigated for the paradigm presented in this section. An unseen data set, consisting of twelve new data points has been used for comparison. The performance of the two methodologies can be seen in Table 3 and FIG. 21.

TABLE 2
Performance of FIS-GrC as compared with a
NN approach, new TS data (12 data points)

| | NN | GrC-FIS |
|---|---|---|
| Measured | Predicted | Predicted |
| TS | TS | TS |
| 1319 | 1268 | 1302 |
| 1354 | 1271 | 1336 |
| 970 | 985 | 1015 |
| 1038 | 982 | 1005 |
| 908 | 1002 | 948 |
| 894 | 945 | 905 |
| 918 | 929 | 942 |
| 909 | 930 | 949 |
| 956 | 930 | 949 |
| 740 | 734 | 852 |
| 737 | 734 | 776 |
| 689 | 698 | 756 |
| | RMSE: 46.23 | RMSE: 46.73 |

The FIS-GrC technique has a comparable performance but not superior as compared to black-box modelling techniques (based on tests on the same application), as it was expected due to the transparency-performance contradictory nature of the objectives.

On the other hand the combination of GrC with a Mamdani FIS offers transparency levels that are by far superior as compared to black-box or grey-box modelling methodologies.

### Incremental Learning/Update of the Structure

Once a model of a system has been developed on the basis of some initial data, when new data are available the system can be modified or expanded to accommodate the new data. This new data is typically derived from operating the system with inputs which differ from those which produced the original data, and in this example is derived from measuring the properties of a number of new alloys. This modification is done by developing a new sub-model or module based on the new data, and then combining the new sub-module with the original model to form a cascaded set of sub-modules as shown in FIG. 22, which can then be used to make predictions based on new data.

Referring to FIG. 23, the process of FIG. 3 for generating the original core model can be summarized as a first step of knowledge discovery and fuzzy rule base formation using the granular clustering process, and a second step of neuro-fuzzy model optimization. The result of this process is the core model.

Referring to FIG. 24, in order to update the model on the basis of new data, the new data is first filtered by the system by comparing them with the existing information granules used to form the rules of the core model, and splitting theme into two categories: ‘real new data’ and ‘partially new data’, The ‘real new data’ consist of data that belong to a totally new area of input space as compared to the original data. This data is therefore suitable for forming new fuzzy rules. The ‘partially new data’ are data that belong or are close to the existing input space of the data set, and are therefore similar to parts of the existing data. This data is therefore suitable for refining fuzzy rules already defined on the basis of the existing data.

In order to categorize each new data vector as ‘real new data’ or ‘partially new data’, the distance of the vector from each of the multidimensional granules of the existing model are determined, and threshold distances defined. These decision thresholds, ‘Threshold Real_New’ and ‘Threshold_Part_New’ are defined by the system designer.

If the new data vector falls within the threshold distance of one of the existing granules, it is identified as a partially new data vector, associated with that granule, and allocated to the partially now data set. If a new data vector does not fall within the threshold distance of any of the existing granules, then it is identified as a real new data vector and allocated to the real new data set.

Each data set is handled differently by the update mechanism. The ‘partially new data’ are used to perform a constrained training (fine-tuning) of the original system, so that the already existing knowledge is not disturbed. Since the input space of the ‘partially new data’ is mostly covered by the system (by one or more sub-modules) there is no need to create a new module but just fine-tune the existing structure. The ‘real new data’ are used to create a new sub-module comprising a new set of rules, using the same GrC-NF modelling procedure of model creation and training as was used for the original model. The new sub-module is then placed in a cascade fashion (as shown in FIG. 22) along with the rest of the sub-modules to form a compound model.

### Model Fusion

After any ‘model update’ processes have been completed, the final model with its cascade structure contains all knowledge required by the system, the individual sub-modules cover both ‘old data’ and ‘new data’ input spaces. It is then ready to be used to predict outputs for new input data. In order to do this, an input vector comprising data which is ‘unseen’ to the system, is input to the model which then makes a prediction of a corresponding output. In order to derive the output, the system is arranged to use an intelligent model fusion process, which is arranged to select and use only some of the sub-models, which are the most appropriate, to determine the output for each input vector.

Referring to FIG. 25, the first stop in this process is that the ‘active’ sub-models each provide a respective individual prediction based on the input data vector. For each ride of each sub-module, a fuzzy entropy value is determined using Shannon's definition as indicated in Equation 1.1 below, (and which is a measure of fuzziness/fuzzy energy) can be calculated for each individual rule of each sub-module network.

### Shannon's Entropy Definition:

$$\begin{matrix}H = - {\sum }_{k = 1}^{N} {u}_{jk} ln ( {u}_{jk} ln ( {u}_{jk} ) \\ = 0 ,\end{matrix} \\ when \\ {u}_{jk} = 0 \\ {u}_{jk} -> fuzzy membership \\ j -> data point \\ k -> no . of rules {(}^{′} {N}^{′} total ) \qquad ( 1.1 )$$

FIG. 26 shows examples of entropy plots for a number of fuzzy rules. This entropy is used to identify a set of representative rules for each sub-module. Generally the representative group are selected as having entropy plots that differ from each other as much as possible. This makes the selected rules representative of the full range of rules making up the sub-module.

Based on the entropy values, some fuzzy-rules can be identified as being more active than others, in particular the rules of one sub-module may be identified as being more active than the rules of the rest of the sub-modules. This indication leads to the conclusion that, for the more active sub-modules, there is a smaller distance (in the multi-dimensional input space of the system) between the input vector and the sub-modules' rule-base (or the data from which the rules were generated), than for other sub-modules. Hence, just the sub-modules that are ‘more active’ are selected to be used for obtaining the model prediction.

FIG. 27 shows an example of how the entropy measure differs between two sample data sets of ‘new data’ and ‘old data’ for two different sub-modules. Representative rules are selected as described above from each of two sub-modules, and its entropy value is plotted for two different data sets, ‘new data’ and ‘old data’. As can be seen on the entropy plot of FIG. 27, the entropy difference between the two data sets is visually obvious. The entropy of the sub-module A is low for the old data but high for new data and vice-versa for the sub-module B. Therefore one can say that the sub-module A is appropriate for making predictions on the ‘new data’ set and sub-module B for the ‘old data’ set. In general the selection process to determine which sub-module is appropriate for which input data is not clear-cut because of the noise present in the data. Therefore this embodiment includes an algorithmic scheme arranged to make an automatic decision to select between any two sub-modules. This process can then be repeated to select from a larger number of sub-modules The algorithmic selection process is a supervised process and operates as follows:

1. Identify a selection of representative rules within each rule-base of a sub-module as described above.

2. Formulate an appropriate comparison index as follows:

CI=e^{(Entropy} ^{_{sub-module}}_A^{-Entropy}^{_{sub-module}}_B)^{^{F}} F→scaling factor (application dependant) (0.1)

3. Define decision thresholds th1, th2 as in FIG. 28

4. Use a fuzzy decision rule-base that acts as follows:

a. If the CI of the input vector is above ‘th1’ then assign prediction to sub-module A.

b. If the CI of the input vector is below ‘th2’ then assign prediction to sub-module B.

c. If the CI of the input vector is below ‘th1’ AND above ‘th2’ then use centre of gravity (COG) defuzzification to obtain a prediction.

FIG. 28 represents how the thresholds th1 and th2 are used to determine what the final outcome of what the prediction should be, i.e, should it be taken from sub-module A or sub-module B (the core model or sub-model) or a combination of the two (i.e. fuzzy decision). The bottom two plots will determine this since they represent the decision making process via the rules represented by the fuzzy membership functions which map the thresholds “th1” and “th2” into the output space (in this example it is the “tensile strength”).

For instance: suppose that the data vector gives a CI (see top figure of 28) that is between “th1” and “th2” (say 0.2), this value will be normalized between “0” and “1” hence, this plot (input space) will include a minimum of normalized “th1” and a maximum of “normalized th2”. The “0.2” (which will be normalized between “0” and “1”) will fire a combination of MFs in this space which will translate into decisions in the output space, via built-in rules.

Clearly the values of “th1” and “th2” will vary from sub-model to sub-model;

In this plot of FIG. 28, th2=0.23 and th1=0.05 then after normalization, th1 will be 0 and th2=1. The firing 0.2 will become (0.2/0.23) in one membership function (MF) and (1−(0.2/0.23)) in the other (the fuzzy principle); which will mean that the prediction will be more influenced by the core model than a sub-model. The result is the aggregation of the two firing strength via the centre of gravity method.

In order to produce an alloy having certain desired properties, the model is first generated, and then used to determine which system inputs, in this case the chemical composition, tempering temperature, cooling medium, etc, will produce an alloy having the required properties. The alloy is then produced by combining the chemical components in the required proportions and tempering and cooling the alloy in the required manner.

### Experimental Studies on the Prediction of Steel Properties

A high dimensional data set, taken from the steel industry, is used for modelling purposes. Each set of points represents 15 input variables and 1 output variable. The input variables include both: a) the chemical composition of steel (i.e. % content of C, Mn, Cr, Ni etc.) and b) the heat treatment data (Tempering temperature, Cooling medium etc.). The output variable is the steel property that needs to be modelled/predicted, in this case the Tensile Strength. The TS data set consists of 3760 data vectors or points, which are divided as follows for the purpose of the incremental learning (IL) modelling:

1. Old data—training (2747 data points)

2. Old data—validation (916 data points)

3. New data—training (72 data points)

4. New data—validation (24 data points)

Care has been taken so that the ‘new data’ set covers mostly an input region that is not covered by the ‘old data’ set (i.e. a new steel grade that is not covered by the ‘old data’ set). The old data set has various steel grades and the new data set contains mostly data for steel with high % weight of Mo. All data sets have been cleaned for spurious or inconsistent data points and the dimensionality of the data space is 16 (15-inputs 1-output). The data space; apart from being highly non-linear and complex, is also very sparse. This is because these industrial data are focused towards specific grades of alloy steel. Hence, there are discontinuities in most of the input dimensions.

### Initial Model Performance

The ‘old data’ training and validation data sets, sets 1 and 2, are used for training and testing the performance of the initial model. After performing data granulation on the training data set the linguistic rule-base of the system is established. The model is then optimised using the adaptive BEP algorithm. The model fit plots (measured vs. predicted) are shown in FIGS. 29 and 30.

### Incremental Learning Performance

The ‘new data’ training and validation data set is then presented to the system. The training data set is filtered by the system as described above to split it tip into two sets named ‘new data’ and ‘partially new data’. The partially new data are used to fine tune the existing NF-GrC model, and the new data are used to create a new NF-GrC sub-module that is trained using the same algorithmic procedure as the initial model. The new sub-module is cascaded along with the rest of the sub-modules in the original structure.

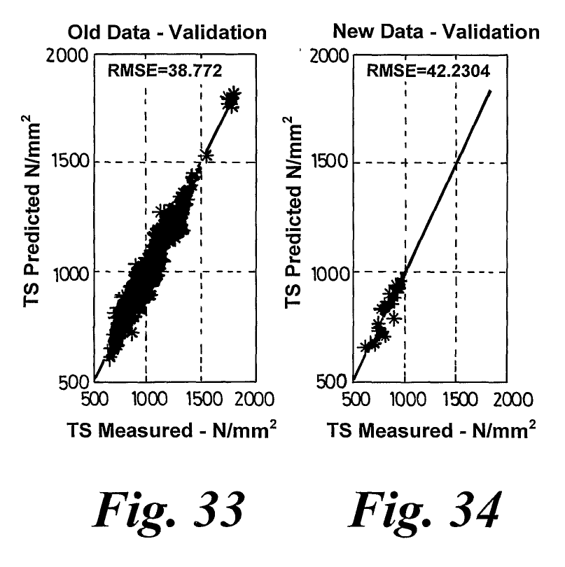

After the incremental update procedure has finished the structure is tested for its performance on the old data set as well as the new data set (training and validation) simultaneously. The results are shown in FIGS. 31 and 32. As seen in the model fit plot (training data sets) the structure is able to maintain the good performance, similar to the one observed in the original model (FIGS. 29 and 30), but at the same time it can predict with comparable accuracy input vectors that originate from the new data set (high ‘Mo’ data). Similar behaviour is observed during the validation tests of the equivalent ‘old’ and ‘new’ data sets, as it is shown in FIGS. 33 and 34. The model is able to handle correctly the unseen input data vectors; when the inputs are excited the appropriate cascade sub-modules are activated, and via the fuzzy fusion process a single prediction is obtained with good accuracy.

Referring to FIG. 35, the models in the examples described above can be represented as a simple processing unit 50 receiving inputs which are the material compositions, tempering temperatures and quenching media, and the outputs of which are the UTS, ROA, elongation, impact and Charpy energy. However, the same process can be used to model a large variety of other processes.

For example, referring to FIG. 36, a model can be made of a patient, and used to predict the patients vital signs, such as blood pressure, heart rate, cardiac output and cardiac index, as well as others such as stroke volume and organ resistance, and how they will vary with changes to certain inputs to the patient, such as inotropic and isotropic drug delivery rates and fluid delivery rates. In this case the sample data is built up by monitoring the response of the patient to various drugs and fluids. Also in this case, referring to FIG. 37, the model can be used as part of a closed loop control system for maintaining the patient in an optimum condition. In one embodiment of the invention, for example, the blood pressure, heart rate, cardiac output, cardiac index and other parameters are monitored by sensors 60. A central controller 62 monitors these parameters using signals from the sensors, and compares them to desired values for the patient 64 that are stored in memory. The controller 62 can then use the model to determine how to control the supply of drugs and fluids to the patient so as to bring their condition towards the desired condition, and directly control the devices 66 that control the supply of drugs and fluids to the patient to achieve the desired results.

The controller 62 is also arranged to monitor the response of the patient to the changes in drug delivery to acquire further sample data while it is in operation. It can then update the patient model, using the model updating processes described above and predetermined optimization parameters, to improve its control over patient, while it is in operation. Such a control apparatus can therefore provide accurate control over the medication provided to a patient so that the condition of the patient approach a preferred condition.

1. A systematic method of generating a neuro-fuzzy structure modelling a system, the method comprising:
recording data relating sample system outputs to sample system inputs,
granulating the data to identify rules relating the inputs to the outputs,
measuring information loss during the granulation process to enable identification of an optimum number of rules, and
constructing the structure so that it has a plurality of processing elements corresponding to the rules.

2. A method according to claim 1 wherein the information loss is measured by measuring a distance between merged granules.

3. A method according to claim 2 wherein the distance is measured in multi-dimensional space having a plurality of dimensions corresponding to a plurality of the inputs and outputs.

4. A method according to claim 1 further comprising displaying data indicative of the information loss.

5. A method according to claim 1 further comprising calculating a measure of the accuracy of the model in different regions of the model and associating the accuracies with the appropriate regions.

6. A method according to claim 1 further comprising calculating a confidence parameter for the model, which is an indication of the accuracy of the model over a range of operating regions of the model.

7. A method of generating a neuro-fuzzy model modelling a system, the method comprising:
recording data relating sample system outputs to sample system inputs,
granulating the data to identify rules relating the inputs to the outputs,
constructing the structure so that it has a plurality of processing elements corresponding to the rules, and
calculating a confidence parameter for the model, which is an indication of the accuracy of the model over a range of operating regions of the model.

8. A method according to claim 7 wherein the confidence parameter is calculated by calculating a membership degree of each granule of the granulated data, calculating a standard deviation associated with each granule, and calculating a confidence parameter from the membership degree and the standard deviation.

9. A method according to claim 8 wherein the confidence parameter is calculated using a T-distribution.

10. A method according to claim 8 wherein the confidence parameter is corrected using a correction factor that includes the ratio of the minimum distance between a current input and every granule to the maximum distance between granules.

11. A method according to claim 7 further comprising a step of reducing the number of inputs for the model produced by the granulation process to simplify the model.

12. A method according to claim 11 wherein the step of reducing the number of inputs comprises calculating for each input an importance factor indicative of the degree to which the input affects at least one output of the model.

13. A method according to claim 12 further comprising removing from the model at least one rule on the basis of its importance factor.

14. (canceled)

15. (canceled)

16. (canceled)

17. A modelling system for producing a neuro-fuzzy model of a modelled system, the modelling system being arranged to:
receive data relating sample system outputs to sample system inputs,
granulate the data to identify rules relating the inputs to the outputs,
measure information loss during the granulation process; and
construct the network so that it has a plurality of processing elements corresponding to the rules.

18. A system according to claim 17 further arranged to display data indicative of the information loss.

19. A system according to claim 17 further arranged to monitor the information loss to identify an optimum number of said rules.

20. A system according to claim 17, wherein the system is capable of, selecting required outputs from a process, and using inputs derived from the model to achieve the required outputs.

21. A system according to claim 20 wherein the process is the production of an alloy.

22. A system according to claim 17 being arranged to identify required outputs of the process, to determine, from the model, inputs that will produce the required outputs, and to control the system inputs to achieve the required outputs.

23. A system according to claim 22 further arranged to monitor outputs from the process and update the model based on those outputs.

24-36. (canceled)
